(19) United States
(12) Patent Application Publication
(10) Pub. No.: US 2014/0053103 A1
(43) Pub. Date: Feb. 20, 2014

(54) METHOD OF ADJUSTING A DISPLAY MODE IN A DEVICE AND THE DEVICE THEREOF

(71) Applicant: Beijing Xiaomi Technology Co., Ltd., Beijing (CN)

(72) Inventors: Weixing Li, Beijing (CN); Peng Sun, Beijing (CN); Yue Cheng, Beijing (CN); Fei Xu, Beijing (CN)

(21) Appl. No.: 13/945,890

(22) Filed: Jul. 18, 2013

(30) Foreign Application Priority Data
Aug. 15, 2012 (CN) 201210291609.X

(51) Int. Cl. G06F 3/0482

(52) U.S. Cl. CPC G06F 3/0482
USPC 715/810

(57) ABSTRACT

A method of adjusting a display mode in a device and the device thereof are provided. The method comprises receiving a user request to select a text mode from a first text mode and a second text mode, wherein the first text mode and the second text mode are preset, the first text mode is associated with a first group of first content elements and the second text mode is associated with a second group of second content elements; retrieving the first content elements if the first text mode is selected or the second content elements if the second text mode is selected; and displaying the retrieved content elements on the device, wherein the first group and the second group are pre-stored in a database. The method of adjusting display modes in the device and the device thereof provided by the present disclosure permit a user to easily adjust the entire display mode of the device to avoid partial or complete overlap.

### CROSS-REFERENCE TO RELATED APPLICATIONS

This application is related to, and claims priority to Chinese Patent Application No. 201210291609.X filed on Aug. 15, 2012, which is incorporated by reference herein in its entirety.

### TECHNICAL FIELD

The present disclosure generally relates to technologies of electronic devices, and more particularly, to a method of adjusting a display mode in a device and the device thereof.

### BACKGROUND

Electronic devices (such as mobile phones, gaming devices, personal digital assistants, and tablet computers) have been configured to display graphic and text. There are ongoing efforts to support and increase the functionality of electronic devices. Such efforts include improvements in both hardware and software components. Recently, the function to adjust or change the text size displayed on the electronic device has been provided to satisfy the requirements of different users. For example, elders want to read text with bigger size due to poor eyesight. Furthermore, some users want to change the color or shape of displayed text. Accordingly, more efficient and effective methods of adjusting a text mode or display mode are needed.

### SUMMARY

In one aspect of the present disclosure, the method of adjusting a display mode in a device comprises receiving a user request to select a text mode from a first text mode and a second text mode, wherein the first text mode and the second text mode are preset, the first text mode is associated with a first group of first content elements and the second text mode is associated with a second group of second content elements; retrieving the first content elements if the first text mode is selected or the second content elements if the second text mode is selected; and displaying the retrieved content elements on the device, wherein the first group and the second group are pre-stored in a database.

In some embodiments, the first content elements and the second content elements comprise a text and/or at least one of a graphic, a glyph, an icon, an image, a video, and any combination of pixels.

In some embodiments, the display attribute of the first content elements is different from the display attribute of the second content elements.

In some embodiments, the display attribute is size, disposition, alignment, color, shape, or any combination thereof.

In some embodiments, the number of the first content elements is different from the number of the second content elements.

In some embodiments, the retrieved content elements are displayed according to a first grid layout if the first text mode is selected or a second grid layout if the second text mode is selected.

In some embodiments, the first grid layout and the second grid layout are configured to accommodate display attributes of the retrieved content elements.

In some embodiments, the first content elements or the second content elements are retrieved by an operating system of the device.

In some embodiments, the displayed content elements form a user interface for interacting with the operation system of the device or an application installed in the device.

In some embodiments, the application installed in the device includes a third party application.

In some embodiments, the first group and the second group are preset by a device provider and/or a third party application provider.

In some embodiments, the retrieved content elements form the user interface for interacting with the third party application if the third party application provider presets content elements for the selected text mode.

In some embodiments, the user request is received via typing in a value, selecting one from a list of text modes, pushing a thumb again one end of a slider, a voice, a gesture, or a posture.

In some embodiments, the method further comprises a step of providing a user interface for allowing a user to viewing and selecting the text mode from the first text mode and the second text mode before the step of receiving the user request.

In some embodiments, each of the first text mode and/or the second text mode comprises one or more sub-text modes, each of which is associated with a subgroup of content elements.

In some embodiments, the database is stored in a memory of the device or a memory of a server.

In another aspect of the present disclosure, the device for adjusting a display mode, comprises a processor; a screen coupled to the processor; and a memory coupled to the processor, wherein the processor is configured to perform steps comprising: receiving a user request to select a text mode from a first text mode and a second text mode, wherein the first text mode and the second text mode are preset, the first text mode is associated with a first group of first content elements and the second text mode is associated with a second group of second content elements; retrieving the first content elements if the first text mode is selected or the second content elements if the second text mode is selected; and displaying the retrieved content elements on the device, wherein the first group and the second group are pre-stored in a database.

In another aspect of the present disclosure, the device for adjusting a display mode comprises means for receiving a user request to select a text mode from a first text mode and a second text mode, wherein the first text mode and the second text mode are preset, the first text mode is associated with a first group of first content elements and the second text mode is associated with a second group of second content elements; means for retrieving the first content elements if the first text mode is selected or the second content elements if the second text mode is selected; and means for displaying the retrieved content elements on the device, wherein the first group and the second group are pre-stored in a database.

In another aspect of the present disclosure, a computer readable recording medium stores one or more programs for use by the processor of the device to perform a process comprising: receiving a user request to select a text mode from a first text mode and a second text mode, wherein the first text mode and the second text mode are preset, the first text mode is associated with a first group of first content elements and the second text mode is associated with a second group of second content elements; retrieving the first content elements if the first text mode is selected or the second content elements if the second text mode is selected; and displaying the retrieved content elements on the device, wherein the first group and the second group are pre-stored in a database.

In another aspect of the present disclosure, a graphical user interface on the device with a screen, a memory and a processor to execute one or more programs stored in the memory, comprises displayed content elements, wherein a user request is received to select a text mode from a first text mode and a second text mode, wherein the first text mode and the second text mode are preset, the first text mode is associated with a first group of first content elements and the second text mode is associated with a second group of second content elements; the first content elements are retrieved if the first text mode is selected or the second content elements if the second text mode is selected; and the retrieved content elements are displayed on the graphical user interface, wherein the first group and the second group are pre-stored in a database.

It is to be understood that both the foregoing general description and the following detailed description of the present disclosure are exemplary and explanatory, and are intended to provide further explanation of the invention as claimed.

### BRIEF DESCRIPTION OF THE DRAWINGS

The accompanying drawings are included to provide a further understanding of the present application and are incorporated in and constitute a part of this specification. The drawings illustrate the embodiments of the present disclosure and together with the description serve to explain the principles of the present disclosure. Other embodiments of the present disclosure and many of the intended advantages of the present disclosure will be readily appreciated, as they become better understood by reference to the following detailed description. The elements of the drawings are not necessarily to scale relative to each other. Like reference numerals designate corresponding similar parts.

FIG. 1 is a block diagram illustrating the device in accordance with some embodiments of the present disclosure.

FIG. 2 is a schematic view illustrating the database for pre-storing one or more groups of content elements in accordance with some embodiments of the present disclosure.

FIGS. 3A to 3B are schematic views of illustrative displays for selecting the text modes in accordance with some embodiments of the present disclosure.

FIG. 4A is a schematic view of an illustrative device display in the first text mode in accordance with some embodiments of the present disclosure.

FIG. 4B is a schematic view of the illustrative device display of FIG. 4A in the second text mode in accordance with some embodiments of the present disclosure.

FIG. 5A is a schematic view of an illustrative device display in the first text mode in accordance with some embodiments of the present disclosure.

FIG. 5B is a schematic view of the illustrative device display of FIG. 5A in the second text mode in accordance with some embodiments of the present disclosure.

FIG. 6A is a schematic view of an illustrative device display in the first text mode in accordance with some embodiments of the present disclosure.

FIG. 6B is a schematic view of the illustrative device display of FIG. 6A in the second text mode in accordance with some embodiments of the present disclosure.

FIG. 7 is a flow diagram illustrating the method of adjusting the display mode in the device 1 in accordance with some embodiments of the present disclosure.

### DESCRIPTION OF EMBODIMENTS

In the following detailed description, reference is made to various specific embodiments of the present disclosure. These embodiments are described with sufficient details to enable those skilled in the art to practice the present disclosure. It is to be understood that other embodiments may be employed, and that various structural, logical, and electrical changes may be made without departing from the spirit or scope of the present disclosure. Wherever possible, the same reference numbers will be used throughout the drawings to refer to the same or like parts.

As used herein, a “device” may be implemented using a variety of terminal devices. Examples of such terminal devices include mobile phones, computers, digital broadcast terminals, messaging devices, gaming consoles, tablets, pads, medical devices, exercise equipment, personal digital assistants, and the like.

As used herein, a “content element” is a text, a graphic, a glyph, an icon, an image, a video, or any combination of pixels. As used herein, a “text mode” comprises size, disposition, alignment, color shape or other display attributes for content element. A device provider or application developer may preset one or more text modes for the device. In some embodiments, the text mode is a font size. Accordingly, the first text mode is a first font size, such as a normal font size and the second text mode is a second font size, such as a large font size.

As used herein, a “group of content elements” comprises a text and/or at least one of a graphic, a glyph, an icon, an image, a video, and any combination of pixels. Each text mode is associated with one corresponding group of content elements; therefore the corresponding content elements are retrieved from the database and displayed on the device when the corresponding text mode is selected. Two or more groups of content elements are predefined by the device provider or application developer and pre-stored in the database.

As used herein, a “database” is used to pre-store two or more groups of content elements. The database may be integrated in any suitable device or combination of devices. For example, the database may be stored in the memory of the device. In another example, the database may be stored in the memory of a server connected to the device.

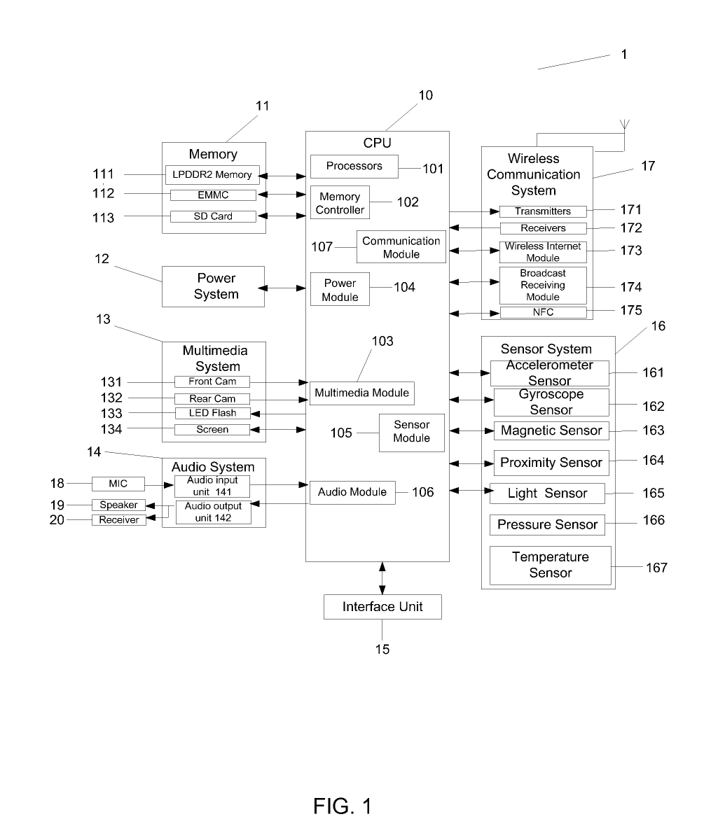

FIG. 1 is a block diagram illustrating the device 1 in accordance with some embodiments of the present disclosure. The device 1 may include a central processing unit (CPU) 10, a memory 11, a power system 12, a multimedia system 13, an audio system 14, an interface unit 15, a sensor system 16, a wireless communication system 17, a microphone (“MIC”) 18, a speaker 19, and a receiver 20.

FIG. 1 illustrates the device 1 as having various components, but it is understood that implementing all of the illustrated components is not required. Greater or fewer components may alternatively be implemented.

The CPU 10 typically controls the overall operations of the device, such as the operations associated with display, calls, data communications, camera operations, and recording operations. The CPU 10 may include one or more processors 101. Moreover, the CPU 10 may include several modules which facilitate the interaction between the CPU 10 and the other systems. In some embodiments, the CPU 10 includes one or more processors 101, a memory controller 102, a multimedia module 103, a power module 104, a sensor module 105, an audio module 106, and a communication module 107. For instance, the CPU 10 includes the multimedia module 103 to facilitate the multimedia interaction between the multimedia system 13 and the CPU 10.

The memory 11 is generally used to store various types of data to support the processing, control, and storage requirements of the device 1. Examples of such data include program instructions for applications operating on the device 1, contact data, phonebook data, messages, pictures, video, etc. The memory 11 shown in FIG. 1 comprises a lower power double data rate 2 (LPDDR2), memory 111, an embedded multimedia card (EMMC) 112, and a secure digital (SD) card 113. However, the memory 11 may also be implemented using any type (or combination) of suitable volatile and non-volatile memory or storage devices, including static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disk, or other similar memory or data storage devices. Access to the memory 11 by other components of the device 1, such as the CPU 10, may be controlled by the memory controller 102.

The power system 12 provides power required by the various components of the device 1. The power system 12 may include a power management system, one or more power sources, and any other components associated with the generation, management, and distribution of power in the device 1. Access to the power system 12 by other components of the device 1, such as the CPU 10, is implemented by the power module 104.

The multimedia system 13 includes a screen 134 providing an output interface between the device 1 and the user. In some embodiments, the screen 134 may comprise a liquid crystal display (LCD) and a touch panel (TP). If the screen 134 includes the touch panel, the screen 134 may be implemented as a touch screen to receive input signals from the users. The touch panel includes many touch sensors to sense touches, swipes, and gestures on the touch panel. The touch sensors may not only sense the boundary of the touch or the swipe action, but may also sense a period of time and a pressure associated with the touch or swipe action. The multimedia module 103 may include a touch-screen control module (not shown in FIG. 1) to receive electrical signals from or send electrical signals to the screen 134. Additionally, in some embodiments, a LED flash 133 is also included in the multimedia system 13.

In some embodiments, the multimedia system 13 comprises a front camera 131 and a rear camera 132. The front camera 131 and rear camera 132 may receive an external multimedia datum while the device 1 is in a particular mode, such as a photographing mode or a video mode. For example, the front camera 131 is located on the front face of the device 1 and the rear camera 132 is located on the back face of the device 1. The camera 131 or 132 may be a fixed optical lens system or may have focus and optical zoom capability.

The audio system 14 includes an audio input unit 141 and an audio output unit 142. The audio input unit 141 is configured to transmit the audio signal received by the MIC 18 to the device 1. The audio output unit 142 is configured to output the processed audio signal to the external components, such as the speaker 19 or the receiver 20. The MIC 18 is configured to receive an external audio signal while the device 1 is in a particular mode, such as a call mode, a recording mode, and a voice recognition mode. This audio signal is processed and converted into digital data. Data generated by the audio input unit 141 may also be stored in the memory 11 or transmitted via one or more modules of the wireless communication system 17.

The interface unit 15 provides the interface between the CPU 10 and peripheral interface modules (not shown in FIG. 1), such as a keyboard, a click wheel, buttons, and the like. The buttons may include but are not limited to a home button, a volume button, a starting button, and a locking button.

The device 1 may also have the sensor system 16, including one or more sensors to provide status measurements of various aspects of the device 1. For instance, the sensor system 16 may detect an open/closed status of the device 1, relative positioning of components (e.g. a display and a keypad) of the device 1, a change of position of the device 1 or a component of the device 1, a presence or absence of user contact with the device 1, orientation or acceleration/deceleration of the device 1, and a change of temperature of the device 1. Access to the sensor system 16 by other components of the device 1, such as the CPU 10, is implemented by the sensor module 105.

The sensor system 16 may include a proximity sensor 164, which is configured to detect the presence of nearby objects without any physical contact. The sensor system 16 may also include a light sensor 165, such as CMOS or CCD image sensors, for use in imaging applications. In some embodiments, the sensor system 16 may also include an accelerometer sensor 161, a gyroscope sensor 162, a magnetic sensor 163, a pressure sensor 166, and a temperature sensor 167 as shown in FIG. 1.

The device 1 may include a wireless communication system 17 configured with several commonly implemented communication components to facilitate communication with other devices. Access to the wireless communication system 17 by other components of the device 1, such as the CPU 10, is implemented by the communication module 107. The wireless communication system 17 typically includes one or more components which permit wireless communication between the device 1 and a wireless communication network. The transmitters 171 are configured to transmit the digital data, for instance, stored in the memory 11, directly to other devices or indirectly over the network. The receivers 172 are configured to receive external digital data directly from other devices or indirectly over the network. If desired, data received by the receivers 172 may be stored in a suitable device, such as the memory 11. The wireless internet module 173 is configured to support internet access for the device 1 by internally or externally coupling to the device 1. The device 1 may be accessed using any type (or combination) of suitable internet connection methods including WIFI, 2G, 3G, and other similar methods.

The broadcast receiving module 174 is configured to receive a broadcast signal and/or broadcast associated information from an external broadcast management entity via a broadcast channel. The broadcast management entity typically refers to a system which can transmit a broadcast signal and/or broadcast associated information. The broadcast receiving module 174 may be configured to receive broadcast signals transmitted from various types of broadcast systems, including but not limited to frequency modulation (FM) broadcasting, digital multimedia broadcasting-terrestrial (DMB-T), and digital multimedia broadcasting-satellite (DMB-S). Receiving multicast signals is also possible. If desired, data received by the broadcast receiving module 174 may be stored in a suitable device, such as the memory 11.

The near field communication (NFC) 175 may facilitate relatively short-range communications. Suitable technologies for implementing this module include radio frequency identification (RFID), infrared data association (IrDA), ultra-wideband (UWB), networking technologies commonly referred to as Bluetooth (BT), and other similar technologies.

The following description explains the method of adjusting a display mode in the device 1 in accordance with some embodiments of the present disclosure. According to the present disclosure, the display mode is adjusted by selecting a particular text mode. A device provider or application developer may preset two or more text modes for the device. In some embodiments, the text mode is a font size. Accordingly, the first text mode is a first font size, such as a normal font size, and the second text mode is a second font size, such as a large font size. In some embodiments, the text mode is a font type. Accordingly, the first text mode is a first font type, such as “Times New Roman” font. The second text mode is a second font type, such as “Century” font. In some embodiments, the text modes may be any combination of the display attributes for text. For example, the first text mode is “Times New Roman” font with a normal font size, and the second text mode is “Century” font with a large font size. Although many of the disclosed embodiments describe the method of adjusting display modes by changing display attributes of text, it should be understood that the present disclosure is not limited to adjusting display modes based on the display attributes of text, but rather generally applicable to all methods of adjusting display modes by selecting particular display attributes of content elements besides the text. Therefore, obvious substitutions now or later known to one with ordinary skill in the art are included within the scope of the present disclosure.

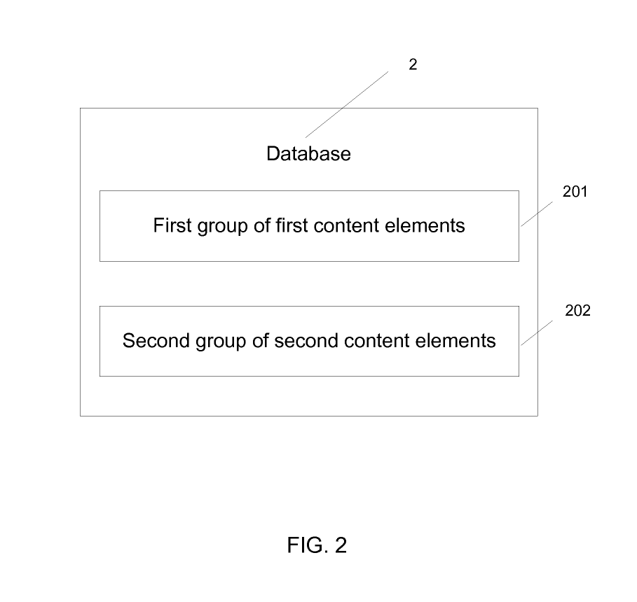

FIG. 2 is a schematic view illustrating the database for pre-storing two or more groups of content elements in accordance with some embodiments of the present disclosure.

The database 2 may be integrated in any suitable device or combination of devices. For example, the database 2 may be stored in the memory 11 of the device 1. In another example, the database 2 may be stored in the memory of a server connected to the device 1 by a communication path. The communication path may include any wired or wireless path through which instructions or content can be transferred between the device 1 and the server. For example, communication paths can include wires, flex circuits, or other physical paths through which an electrical signal can be transmitted. In another example, communication paths can also include wireless paths. The wireless communication path can support any suitable communication protocol, or any suitable type of communications network. The server may include any electronic devices which may store the database 2. For example, the server may include a remote server, a cloud server, a local storage device, or another device (such as a desk or notebook computer, a tablet or a cellular telephone) connected to the device 1.

The database 2 pre-stores two or more groups of content elements. Each of the groups of content elements is associated with a text mode. In the exemplary embodiment, as illustrated in FIG. 2, a first group of first content elements 201 and a second group of second content elements 202 are stored in the database 2. Obviously, more than two groups of content elements may be pre-stored in the database 2 if more than two text modes are preset.

The first group 201 is associated with a first text mode. Additionally, in some embodiments, the database 2 stores the first group using the first text mode as a database path name. Therefore, the first content elements in the first group 201 may be retrieved by using the first text mode as a retrieving index. Similarly, the second group 202 is associated with a second text mode. The second content elements in the second group 202 may be retrieved by using the first text mode as the retrieving index.

Each of the first group and second group comprises a text and/or at least one of a graphic, a glyph, an icon, an image, a video, and any combination of pixels. The display attributes of the first content elements and second content elements comprise at least one of a size, a disposition, an alignment, a color, and any combination thereof. In some embodiments, the retrieved content elements are displayed in the screen 134 to form a user interface to interact with the operation system of the device or an application installed in the device.

For example, each of the two groups includes a subset of content elements to be applied in a home screen user interface. The subset of content elements to be applied in the home screen user interface includes a plurality of icons as well as texts describing the icons. The display attributes of the icons include the size and disposition of the icons. The display attributes of the texts include font size, font type, and text dispositions. In another example, each of the two groups includes a subset of content elements to be applied in interfaces to interact with a third party application, provided that the third party application provider presets two groups of content elements for the two text modes.

The device provider or a third party application developer may predefine the first group and second group in accordance with the first text mode and second text mode. For example, if the first text mode is a normal font size, the display attributes of all of the content elements in the first group are preset to ensure that a user can adequately distinguish the content and interact with the device in a normal text font size. If the second text mode is a large text font size, the display attributes of all of the content elements in the second group are adjusted to ensure that the display attributes of all of the content elements may match with the large text size and avoid partial or complete overlap. In other words, the display attributes of other content elements besides the text are pre-adjusted to adapt to the adjustment of the text size and then stored in the database 2. For example, the resolution and size of icons of the second group is predefined on the basis of the second text mode to ensure the size of icons matches with the text size in the second text mode.

Additionally, a first grid layout associated with the first text mode is configured for the first group, and a second grid layout associated with the second text mode is configured for the second group. For example, if the first text mode is a normal font size, the retrieved content elements are displayed according to a first grid layout 3*4. If the second text mode is a large text font size, the retrieved content elements are displayed according to a second grid layout 2*3. Upon receiving an instruction to display the first content elements in the first group, the first content elements may be retrieved and displayed with the predefined first grid layout. In the same manner, upon receiving an instruction to display the second content elements in the second group, the second content elements may be retrieved and displayed with the predefined second grid layout. Details of the first second grid layout and second grid layout will be described referring to the user interface display diagrams below.

Although only the first group 201 associated with the first text mode and the second group 202 associated with the second text mode are described in the exemplary embodiment as illustrated in FIG. 2, more than two groups of content elements may be pre-stored in the database 2 if more than two text modes are preset. In the present disclosure, there may be two or more text modes. Furthermore, each of the two or more text modes may comprise one or more sub-text modes, each of which is associated with a subgroup of content elements.

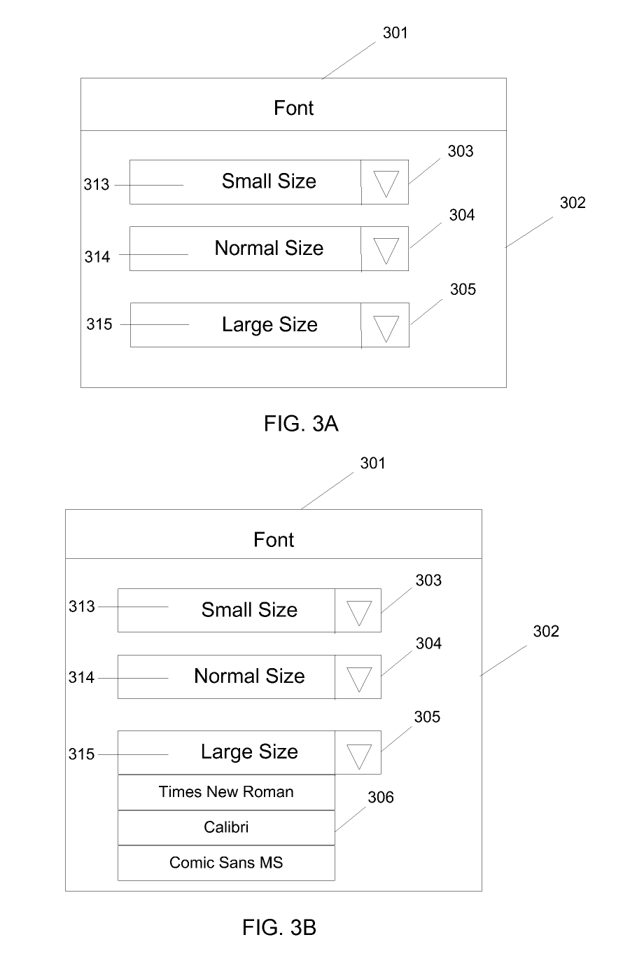

FIGS. 3A to 3B are schematic views of illustrative displays for selecting the text modes in accordance with some embodiments of the present disclosure.

As shown in FIG. 3A, the device 1 displays a window to receive the user input for selecting text modes. The window may comprise a title bar 301 and a main panel 302. The title bar 301 indicates the display mode of the device 1 will be adjusted on the basis of text mode. The main panel 302 comprises a list of text mode bars, such as a first text mode bar 313, a second text mode bar 314, and a third text mode bar 315. Accordingly, in the exemplary embodiment, the first text mode bar corresponds to a “small size” text mode. Moreover, the second text mode bar corresponds to a “normal size” text mode and the third text mode bar corresponds to a “large size” text mode. The user may select one of the three text modes by touching the corresponding text mode bar or by pointing a cursor at the corresponding text mode bar and pressing a button such as a home button. The device 1 retrieves the corresponding content elements associated with the selected text mode from the database 2 and displaying the retrieved content elements on the device. Accordingly, if the “large size” text mode is selected, the texts (characters and text strings) in the user interfaces of the device 1 are displayed with a large size, and the grid layout and display attributes of other display items are changed accordingly.

Preferably, each of the text mode bars 313, 314, and 315 comprises a pop-up menu button 303, 304, and 305. When activated, the pop-up menu buttons 303, 304, and 305 show a list of sub-text modes in a pop-up window 306, from which the user can select one of sub-text modes, such as “Times New Roman Font,” “Calibri Font,” “Comic Sans MS Font,” and the like. Each of the sub-text modes is associated with a subgroup of content elements. The subgroup of content elements is pre-defined by the device provider and stored in the database 2. If one of the sub-text modes is elected, the corresponding subgroup of content elements is retrieved and applied to display items in the device 1. Although the sub-text modes as shown in FIG. 3B include the font types of the text, it is obvious that the sub-text modes according to the present disclosure can be font color, font orientation, alignment, or other display attributes of the text.

Furthermore, it should be understood that the present disclosure is not limited to selecting the text modes from a list, but is generally applicable to all text mode selection methods such as a voice, a gesture, posture, or pushing a thumb against one end of a slider. For example, the user may select one of the text modes, such as the “large size” text mode, by providing a voice signal “large size” to the device 1. The device 1 then receives and processes the voice signal to determine that the “large size” text mode is selected. Therefore, obvious substitutions now or later known to one with ordinary skill in the art are to be within the scope of the present disclosure.

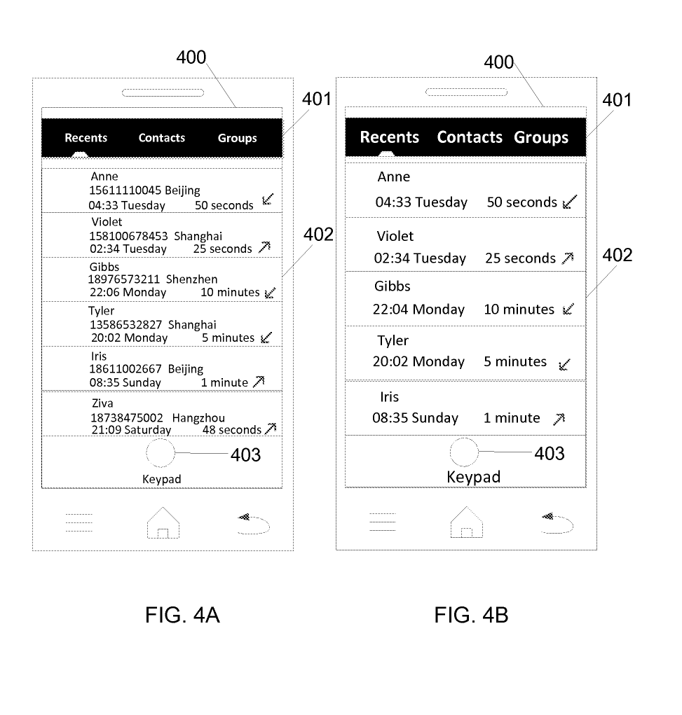

FIG. 4A is a schematic view of an illustrative device display in the first text mode in accordance with some embodiments of the present disclosure. In the exemplary embodiment as shown in FIG. 4A, the first text mode is a “Normal size” text mode. Because FIG. 4A shows a “recent call” user interface of the telephone application, the user interface 400 includes a title bar 401, a list 402 of recent call records, and a keypad icon 403. Both the title bar 401 and the list 402 can include text, graphics, images, or other content elements according to features of the telephone application. For example, the title bar 401 can include three text strings, such as “Recents,” “Contacts,” and “Groups.” The list 402 as shown in FIG. 4A can include a series of call record items, and each of the call record items include five text strings, such as “contact person,” “phone number,” “address,” “call time,” “call duration,” and an arrow icon. For example, the first call record item in the list 402 as shown in FIG. 4A includes five text strings: “Anne;” “15611110045;” “Beijing;” “04:33 Tuesday;” “50 Seconds;” and a down arrow icon which indicates the call is received by the user. The keypad icon 403 is displayed with a text string “keypad” below it.

The content elements in the user interface of FIG. 4A include all of the text strings as well as the “keypad” icon. All of the content elements in the user interface are formed by retrieving the first content elements in the first group and displaying the content elements for the “recent call” user interface. The display attributes, such as the size of the content elements to be applied to the “recent call” user interface, are predefined and stored. Furthermore, the number of the first contents elements is predefined by the application developer. For example, each of the call record items in the list 402 includes six content elements, comprising five text strings and one icon. Because FIG. 4A is the schematic view of the user interface for the telephone application in a “Normal size” text mode, all of the content elements, i.e. the text strings and icons, are displayed in a normal size. In other words, both the number of the first content elements and the first content elements' display attributes are predefined to accommodate the “Normal size” text mode.

FIG. 4B is a schematic view of the illustrative device display of FIG. 4A in the second text mode in accordance with some embodiments of the present disclosure. In the exemplary embodiment as shown in FIG. 4B, the second text mode is a “Large size” text mode. The user interface as shown in FIG. 4B is the same as the user interface shown in FIG. 4A, except for the selected text mode. Therefore, the user interface 400 as shown in FIG. 4B also includes a title bar 401, a list 402 of recent call records, and a keypad icon 403. The title bar 401 includes three text strings, such as “Recents,” “Contacts,” and “Groups,” while the list 402 includes a series of call record items. However, each of the call record items as shown in FIG. 4B only include three text strings, such as “contact person,” “call time,” “call duration,” and an arrow icon. For example, the first call record item in the list 402 as shown in FIG. 4B only includes three text strings: “Anne;” “04:33 Tuesday;” “50 Seconds;” and the down arrow icon.

It is obvious that FIG. 4B's text strings are larger than FIG. 4A's text strings. Moreover, the content elements in FIG. 4B's call record item are different from the content elements in FIG. 4A's call record item. Although there are five text strings: “contact person;” “phone number;” “address;” “call time;” and “call duration” included in FIG. 4A's call record item, there are only three text strings: “contact person;” “call time;” and “call duration” included in FIG. 4B's call record item to adapt to the large size of the text strings.

According to the present disclosure, the text strings' size in the second group is predefined as larger than the size of the text strings' size in the first group. Moreover, the number of the second content elements in the second group is also predefined to be different from the number of the first content elements in the first group to avoid overlap. By permitting the application developer to pre-adjust the display attributes and the number of the content elements in each group, the present disclosure's method may provide a best display mode without any overlap in the selected text mode.

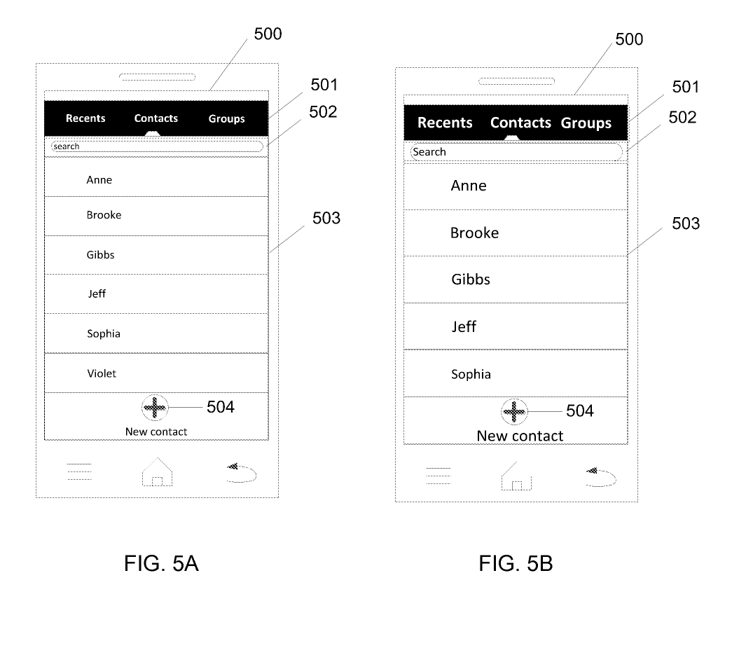

FIG. 5A is a schematic view of an illustrative device display in the first text mode in accordance with some of the present disclosure's embodiments. In the exemplary embodiment as shown in FIG. 5A, the first text mode is a “Normal size” text mode. Because FIG. 5A shows a “contact” user interface of the telephone application, the user interface 500 includes a title bar 501, a list 503 of contact persons, a search bar 502, and an “add new contact” icon 504. The search bar 504 includes a text string “search” to indicate that the user may input the name of a certain contact person to search for him/her. The list 503 of contact persons as shown in FIG. 5A can include a series of contact persons such as “Anne,” “Brooke,” “Gibbs,” “Jeff,” “Sophia,” and “Violet.” There are 6 contact person items included in the list 503 as shown in FIG. 5A. Furthermore, the “add new contact” icon 504 is displayed with a text string “New contact” below it.

The content elements in the user interface of FIG. 5A include all of the text strings as well as the “add new contact” icon. All of the content elements in the user interface are formed by retrieving the first content elements and displaying the first content elements for the “contact” user interface. The display attributes, such as the size of the content elements to be applied to the “contact” user interface, is predefined and stored. Furthermore, the retrieved first content elements are displayed according to a first grid layout in the “contact” user interface in FIG. 5A. For example, the list 503 as shown in FIG. 5A includes 6 items.

FIG. 5B is a schematic view of the illustrative device display of FIG. 5A in the second text mode in accordance with some embodiments of the present disclosure. In the exemplary embodiment as shown in FIG. 5B, the second text mode is a “Large size” text mode. The user interface as shown in FIG. 5B is the same as the user interface as shown in FIG. 5A, except for the selected text mode. Therefore, the user interface 500 as shown in FIG. 5B also includes a title bar 501, a list 503 of contact persons, a search bar 502, and an “add new contact” icon 504. However, the list 503 of contact persons as shown in FIG. 5B only includes five contact persons, such as “Anne,” “Brooke,” “Gibbs,” “Jeff,” and “Sophia.”

Obviously, the size of FIG. 5B's text strings is larger than the size of FIG. 5A's text strings. Moreover, the grid layout for the list 502 in FIG. 5B is different from the grid layout for the list 502 in FIG. 5A. Although there are six rows included in the list of contact persons in FIG. 5A, there are only five rows included in the list of contact persons in FIG. 5B to adapt to the text strings' large size.

According to the present disclosure, the size of the text string in the second group is predefined as larger than the size of the text strings in the first group. Moreover, the grid layout associated with the “Large size” text mode is also predefined to be different from the grid layout associated with the “Normal size” text mode in order to avoid a tight layout of the content elements in the “Large size” text mode. By permitting the application developer to pre-adjust the display attributes and grid layout of the content elements for each group of content elements, the present disclosure's method may provide an appropriate display mode in the selected text mode.

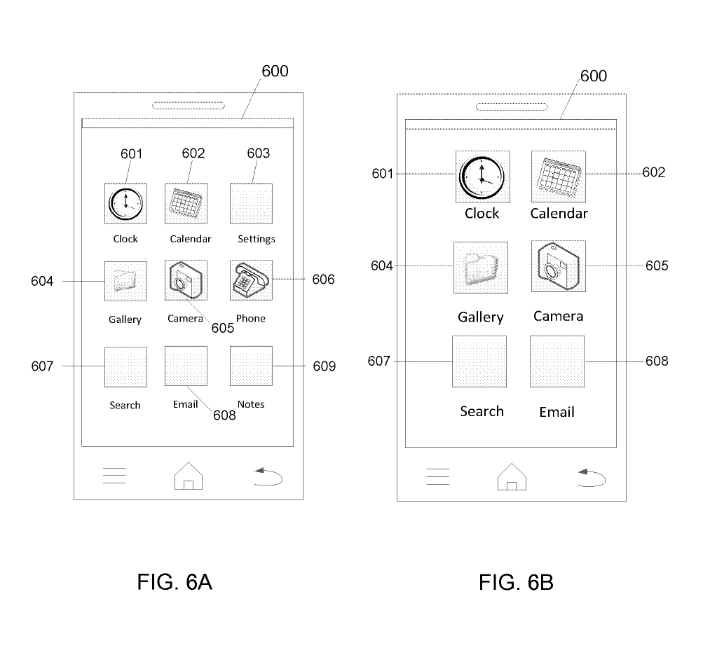

FIG. 6A is a schematic view of an illustrative device display in the first text mode in accordance with some embodiments of the present disclosure. In the exemplary embodiment as shown in FIG. 6A, the text mode is a “Normal size” text mode. Because FIG. 6A shows a “home screen” user interface, the user interface 600 includes a series of icons such as a clock icon 601, a calendar icon 602, a settings icon 603, a gallery icon 604, a camera icon 615, a phone icon 606, a search icon 607, an email icon 608, and a notes icon 609. Each of the said icons includes a text string indicating the icon's name below the corresponding icon. The grid layout for arranging the icons is 3*3 as shown in FIG. 6A; therefore, there are three rows of icons in the user interface and each of the rows includes three icons respectively.

FIG. 6B is a schematic view of the illustrative device display of FIG. 6A in the second text mode display with some embodiments of the present disclosure. In the exemplary embodiment as shown in FIG. 6B, the text mode is a “Large size” text mode. The user interface as shown in FIG. 6B is the same as the user interface as shown in FIG. 6A, except for the selected text mode. In other words, FIG. 6A illustrates the “home screen” user interface in the “Normal size” text mode, and FIG. 6B illustrates the “home screen” user interface in the “Large size” text mode. The user interface 600 in FIG. 6B includes a series of icons such as a clock icon 601, a calendar icon 602, a gallery icon 604, a camera icon 615, a search icon 607, and an email icon 608. Each of the icons includes a text string indicating the icon's name below the corresponding icon. However, because the grid layout for arranging the icons is 2*3 as shown in FIG. 6B, there are three rows of icons in the user interface, and each of the rows only includes two icons respectively.

As shown in FIGS. 6A and 6B, the size of FIG. 6B's text strings is larger than the size of FIG. 6A's text strings. Moreover, the size of FIG. 6B's icons is larger than FIG. 6A's icons. Furthermore, the grid layout associated with the “Large size” text mode is also predefined to be different from the grid layout associated with the “Normal size” text mode. Therefore, according to the present disclosure, not only are the display attributes of the first group' text different from the display attributes of the second group' text, but the display attributes of other content elements, such as icons in the first group, may be different from the corresponding content elements' display attributes in the second group. Furthermore, the grid layout for displaying the first content elements in the first group may be different from the grid layout for displaying the second content elements in the second group to accommodate display attributes of the corresponding content elements. The display attributes of the content elements in each group of content elements and the grid layout associated with each text mode are predefined to permit the device 1 to easily retrieve the content elements associated with the selected text mode from the database 2 and display the retrieved content elements according to the corresponding grid layout.

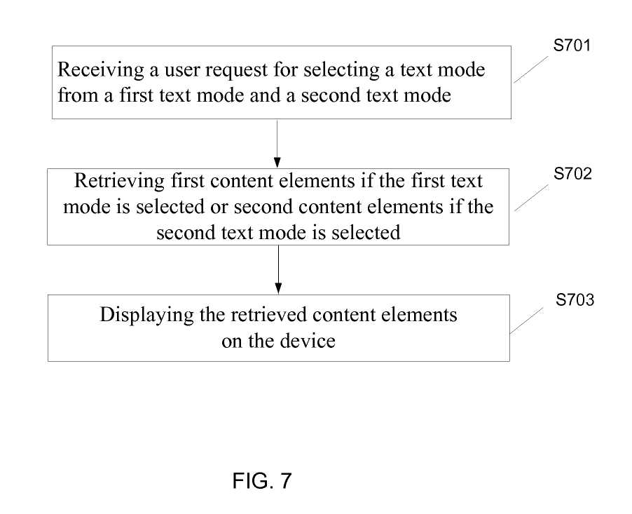

FIG. 7 is a flow diagram illustrating the method of adjusting the display mode in the device 1 in accordance with some embodiments of the present disclosure. While the process flow described below includes a plurality of steps that appear to occur in a specific order, it should be apparent that those procedures may include either fewer or more operations, which may be executed serially or in parallel.

Referring to FIG. 7, in step 701a user request for selecting a text mode from a first text mode and a second text mode is received. If the first text mode is selected by the user, the first content elements in the first group associated with the first text mode are retrieved in step 702. If the second text mode is selected by the user, the second content elements in the second group are retrieved accordingly in step 702. In step 703, the retrieved content elements associated with the selected mode are displayed on the device. According to the present disclosure, the first text mode and the second text mode are preset by the device provider or application developer.

Preferably, the first or second content elements are retrieved by an operating system of the device 1; therefore, the displayed content elements form all of the user interfaces for interacting with the operation system of the device or an application installed in the device. For example, the user interfaces comprise a “home screen” user interface, a “locked status” user interface, a “recent call” user interface of the telephone application, a “capturing image” user interface of a camera application, a “drafting message” user interface of a short message application, a “web browser” user interface of a web browser application, and the like.

Preferably, the application may be a third party application if the third party application provider presets content elements for the first text mode and the second text mode. In step S702, the device 1's operating system will detect whether the third party application provider presets content elements for the selected text mode. If the operating system determines that the third party application provider presets content elements for the selected text mode, the third party application's content elements will be retrieved and applied to the third party application's user interface. Therefore, the present disclosure provides an “interface” to permit the developer of the third party application to easily predefine the third party application's content elements for each text mode.

Preferably, in step S703, the retrieved content elements are displayed according to a first grid layout if the first text mode is selected or a second grid layout if the second text mode is selected. For example, when displaying a “home screen” user interface, the retrieved first content elements are displayed according to the first grid layout 3*3 if the “Normal size” text mode is selected, and the retrieved second content elements are displayed according to the second grid layout 2*3 if the “Large size” text mode is selected.

As explained above, the method and device for adjusting the display mode, according to the present disclosure, does so through the operation the device's operating system. Therefore, the display attributes of the texts displayed in the device, including the text in the user interface of the third party application, may be adjusted. Furthermore, the number of the content elements displayed in the user interface, the grid layout configured to display the content elements, and the display attributes of other content elements besides the text, are adjusted at the same time to avoid the content elements overlapping. Therefore, the present disclosure may easily provide a best display mode without partial or complete overlap in the selected text mode by predefining and storing a corresponding group of content elements associated with the selected text mode.

Various embodiments described herein may be implemented in a computer-readable recording medium storing one or more programs for use by one or more processors 101. The computer can also include the CPU 10 of the device 1.

The computer-readable recording medium may use, for example, computer software, hardware, or some combination thereof. For a hardware implementation, the embodiments described herein may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof.

For a software implementation, the embodiments described herein may be implemented with separate software modules, such as procedures and functions, each of which perform one or more of the functions and operations described herein. The software codes can be implemented with a software application written in any suitable programming language and may be stored in memory (e.g., memory 11).

The aforementioned methods can be implemented in a computer readable media recording computer-readable codes. The computer-readable media include all kinds of recording devices in which data readable by a computer system are stored. The computer-readable media include ROM, RAM, CD-ROM, magnetic tapes, floppy discs, optical data storage devices, and the like, as well as carrier-wave type implementations (e.g., transmission via Internet).

The foregoing description, for purpose of explanation, has been described with reference to embodiments. The present disclosure may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

What is claimed is:

1. A method of adjusting a display mode in a device, comprising:
receiving a user request to select a text mode from a first text mode and a second text mode, wherein the first text mode and the second text mode are preset, the first text mode is associated with a first group of first content elements and the second text mode is associated with a second group of second content elements;
retrieving the first content elements if the first text mode is selected or the second content elements if the second text mode is selected; and
displaying the retrieved content elements on the device,
wherein the first group and the second group are pre-stored in a database.

2. The method of claim 1, wherein the first content elements and the second content elements comprise a text and/or at least one of a graphic, a glyph, an icon, an image, a video, and any combination of pixels.

3. The method of claim 2, wherein the display attribute of the first content elements is different from the display attribute of the second content elements.

4. The method of claim 3, wherein the display attribute is size, disposition, alignment, color, shape, or any combination thereof.

5. The method of claim 2, wherein the number of the first content elements is different from the number of the second content elements.

6. The method of claim 2, wherein the retrieved content elements are displayed according to a first grid layout if the first text mode is selected or a second grid layout if the second text mode is selected.

7. The method of claim 6, wherein the first grid layout and the second grid layout are configured to accommodate display attributes of the retrieved content elements.

8. The method of claim 1, wherein the first content elements or the second content elements are retrieved by an operating system of the device.

9. The method of claim 8, wherein the displayed content elements form a user interface for interacting with the operation system of the device or an application installed in the device.

10. The method of claim 9, wherein the application installed in the device includes a third party application.

11. The method of claim 10, wherein the first group and the second group are preset by a device provider and/or a third party application provider.

12. The method of claim 11, wherein the retrieved content elements form the user interface for interacting with the third party application if the third party application provider presets content elements for the selected text mode.

13. The method of claim 1, wherein the user request is received via typing in a value, selecting one from a list of text modes, pushing a thumb again one end of a slider, a voice, a gesture, or a posture.

14. The method of claim 13, further comprising a step of providing a user interface for allowing a user to viewing and selecting the text mode from the first text mode and the second text mode before the step of receiving the user request.

15. The method of claim 1, wherein each of the first text mode and/or the second text mode comprises one or more sub-text modes, each of which is associated with a subgroup of content elements.

16. The method of claim 1, wherein the database is stored in a memory of the device or a memory of a server.

17. A device for adjusting a display mode, comprising:
a processor;
a screen coupled to the processor; and
a memory coupled to the processor,
wherein the processor is configured to perform steps comprising:
receiving a user request to select a text mode from a first text mode and a second text mode, wherein the first text mode and the second text mode are preset, the first text mode is associated with a first group of first content elements and the second text mode is associated with a second group of second content elements;
retrieving the first content elements if the first text mode is selected or the second content elements if the second text mode is selected; and
displaying the retrieved content elements on the device,
wherein the first group and the second group are pre-stored in a database.

18. The device of claim 17, wherein the first content elements and the second content elements comprise a text and/or at least one of a graphic, a glyph, an icon, an image, a video, and any combination of pixels.

19. A computer readable recording medium storing one or more programs for use by a processor of a device to perform a process comprising:
receiving a user request to select a text mode from a first text mode and a second text mode, wherein the first text mode and the second text mode are preset, the first text mode is associated with a first group of first content elements and the second text mode is associated with a second group of second content elements;
retrieving the first content elements if the first text mode is selected or the second content elements if the second text mode is selected; and
displaying the retrieved content elements on the device,
wherein the first group and the second group are pre-stored in a database.

20. The computer readable recording medium of claim 19, wherein the first content elements and the second content elements comprise a text and/or at least one of a graphic, a glyph, an icon, an image, a video, and any combination of pixels.
